(19) United States
(12) Patent Application Publication
(10) Pub. No.: US 2019/0368831 A1
(43) Pub. Date: Dec. 5, 2019

(54) HEAT DISSIPATION BAND FOR INTERCOOLER

(71) Applicant: Fincool Tech LLC, Stafford, TX (US)

(72) Inventor: Tongzeng XU, Stafford, TX (US)

(73) Assignee: Fincool Tech LLC, Stafford, TX (US)

(21) Appl. No.: 15/996,326

(22) Filed: Jun. 1, 2018

(51) Int. Cl. F28F 21/08; F02B 37/02; F28F 3/02; F02B 29/04

(52) U.S. Cl. CPC F28F 21/089; F02B 37/02; F02D 41/0007; F02B 29/0456; F28F 2245/06; F28F 3/025

(57) ABSTRACT

The present disclosure generally provides an improved heat dissipation band for an intercooler. In one embodiment, the heat dissipation band includes a heat dissipation band, the heat dissipation band being in a shape of a continuous sinusoidal waveform having peaks and troughs, and the heat dissipation band comprising a plurality of band bodies formed between peaks and troughs of the waveform, a plurality of cuts formed in band bodies, wherein a band body portion corresponding to each cut forms a protrusion protruding out of the band body in the cut direction, a first feature layer formed on exposed surface of the heat dissipation band, and a second feature layer formed on the first feature layer, the second feature layer being different from the first feature layer.

### FIELD

The present disclosure relates to an intercooler of an internal combustion engine, and in particular, to a heat dissipation band for an intercooler.

### BACKGROUND

An intercooler is an important component of a turbo-charged engine system. The intercooler cools the supercharged high-temperature gas, which reduces the thermal load of the engine and improves the service life of the engine. After the supercharged air is cooled, the mass and the flow of air entering the engine are increased, thus improving the power and reducing oil consumption. Harmful exhaust gas emission is therefore reduced.

A heat dissipation band is an important part in the components of the intercooler. The shape and structure of the heat dissipation band are directly related to the heat dissipation effect of the intercooler. The essence of the intercooler is to reduce the temperature of the medium to achieve the effect of heat dissipation. Therefore, the heat dissipation band is profoundly important for the intercooler.

### SUMMARY

To enhance the heat dissipation effect of the intercooler, an objective of the present disclosure is to provide a heat dissipation band for an intercooler. Cuts are formed in a band body of the heat dissipation band by pressing through rolling, thus enhancing the heat dissipation effect of the intercooler.

In one embodiment, the heat dissipation band includes a heat dissipation band, the heat dissipation band being in a shape of a continuous sinusoidal waveform having peaks and troughs, and the heat dissipation band comprising a plurality of band bodies formed between peaks and troughs of the waveform, a plurality of cuts formed in band bodies, wherein a band body portion corresponding to each cut forms a protrusion protruding out of the band body in the cut direction, a first feature layer formed on exposed surface of the heat dissipation band, and a second feature layer formed on the first feature layer, the second feature layer being different from the first feature layer.

In another embodiment, the heat dissipation band includes a heat dissipation band, the heat dissipation band being in a shape of a continuous sinusoidal waveform having peaks and troughs, and the heat dissipation band comprising a plurality of band bodies formed between peaks and troughs of the waveform, and a plurality of cuts formed in band bodies, wherein a band body portion corresponding to each cut forms a protrusion protruding out of the band body in the cut direction.

### BRIEF DESCRIPTION OF THE DRAWINGS

Implementations of the present disclosure, briefly summarized above and discussed in greater detail below, can be understood by reference to the illustrative implementations of the disclosure depicted in the appended drawings. It is to be noted, however, that the appended drawings illustrate only typical implementations of this disclosure and are therefore not to be considered limiting of its scope, for the disclosure may admit to other equally effective implementations.

FIG. 1 is a structural front view of a heat dissipation band according to embodiments of the present disclosure;

FIG. 2 is a cross-sectional view of the heat dissipation band taken along line A-A in FIG. 1;

FIG. 3 is a partial enlarged view of the region I in FIG. 2;

FIG. 4 is a prospective view of the heat dissipation band according to embodiments of the present disclosure; and

FIG. 5 is a partial enlarged view of the region II in FIG. 3.

To facilitate understanding, identical reference numerals have been used, where possible, to designate identical elements that are common to the figures. The figures are not drawn to scale and may be simplified for clarity. It is contemplated that elements and features of one implementation may be beneficially incorporated in other implementations without further recitation.

### DETAILED DESCRIPTION

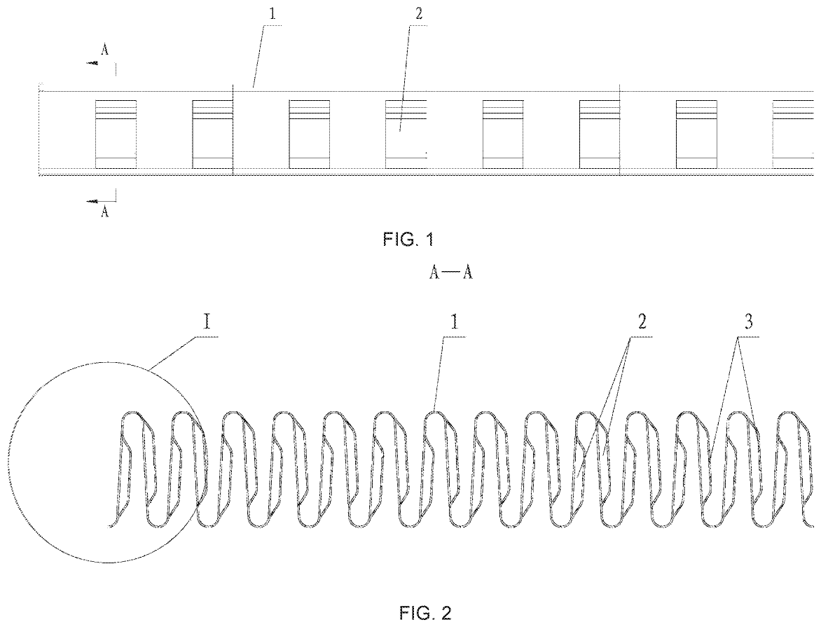

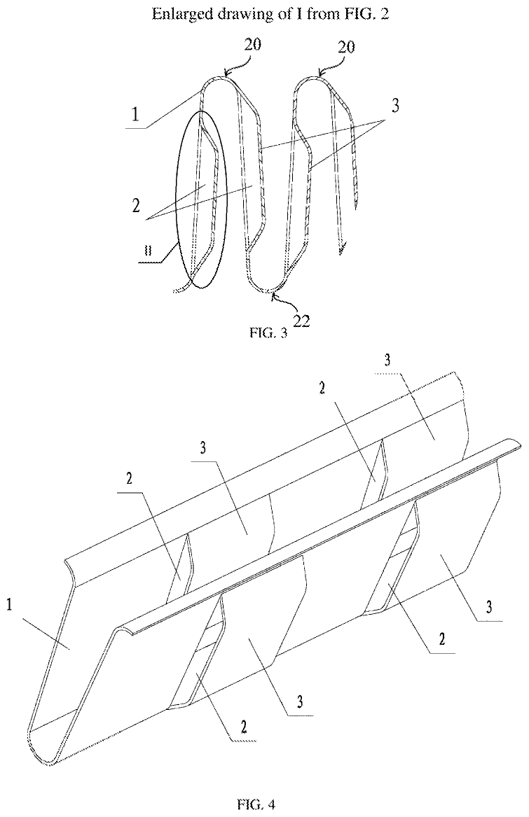

As shown in FIGS. 1 to 4, a heat dissipation band 1 of the present disclosure is provided. The heat dissipation band 1 is generally in a shape of a sine waveform having peaks 20 and troughs 22. The band bodies of the heat dissipation band 1 are located between peaks and troughs of the waveform. A plurality of cuts 2 are formed in the band bodies between peaks and troughs of the waveform. The cuts 2 may be evenly distributed along the longitudinal direction of the band body. Each of the band bodies may have the same number of cuts. In some embodiments, the cuts 2 are formed with identical sizes and shapes. The cuts 2 may be formed by pressing through rolling.

The cuts 2 on each band body have the same opening direction. A band body portion corresponding to each cut 2 forms a protrusion 3 protruding out of the band body in the cut direction. The protrusions 3 on the band bodies are all located at the same side of the band bodies. The bottom of the protrusion 3 is parallel with the band body.

The height of the cuts 2 on the band bodies of the same waveform are the same. The height of the cuts 2 in the band bodies at the same side of the waveforms are the same. In addition, the height of the cuts 2 in two band bodies of a same waveform is different.

The heat dissipation band 1 of the present disclosure is formed of a double-sided composite material. The material of the core material is aluminum alloy 3003, and the surface material is aluminum alloy 4343. It is contemplated that other material, such as silicon carbide or silicon carbon nitride, may also be used for the surface material.

A cooling medium can pass through the position between every two adjacent cuts formed in the band body of the heat dissipation band 1. When a cooling medium passes through the positions of the cuts 2, the cuts 2 hinder air flow, which in turn changes the direction of air flow. As a result, the air flow forms a cross flow and thus increases air flow turbulence. The cuts with different heights in the heat dissipation band 1 enable vortexes to be similarly generated at positions of the peaks and the troughs of the waveforms, thereby greatly improving the heat dissipation efficiency. Therefore, the heat dissipation effect of the intercooler is enhanced.

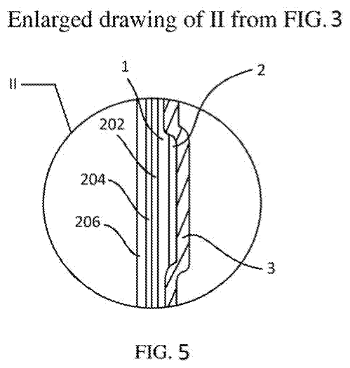

In some embodiments, the exposed surface of the heat dissipation band 1 may be coated with one or more layers to provide thermal absorptivity properties to help cool down the intercooler. For example, in some embodiments, a first feature layer 202 may be provided on the exposed surface of the heat dissipation band 1, as shown in FIG. 5, which is a partial enlarged view of the region II in FIG. 3. In one embodiment, the first feature layer 202 is a thin glass layer formed of borosilicate glass. In another embodiment, the first feature layer 202 is a polyurethane material. The polyurethane material can provide required thermal absorptivity properties for the heat dissipation band 1. The first feature layer 202 may be formed from other heat absorptive material, such as a carbon black paint or graphite. In yet another embodiment, the first feature layer 202 may be a bi-layer stack having a layer of borosilicate glass and a layer of polyurethane material.

In some embodiments, a second feature layer 204 may be conformally formed on the first feature layer 202. The second feature layer 204 is a high performance material (HPM) that may be produced from raw ceramic powders of Y₂O₃, Al₂O₃, and ZrO₂. In one exemplary example, the second feature layer 204 is formed of Y₂O₃ in a range between about 45 mol. % and about 100 mol. % ZrO₂ in a range from about 0 mol. % and about 55 mol. %, and Al₂O₃ in a range from about 0 mol. % to about 10 mol. %. In one exemplary example, the second feature layer 204 may be formed of Y₂O₃ in a range between about 30 mol. % and about 60 mol. % ZrO₂ in a range from about 0 mol. % and about 20 mol. %, and Al₂O₃ in a range from about 30 mol. % to about 60 mol. %.

In some cases, the second feature layer 204 is composed of at least a compound YₓZr_{y}Al_{z}O. The second feature layer 204 may have a graded composition across its thickness. In one exemplary example, the second feature layer 204 may contain Y₂O₃ having a molar concentration gradually changing from about 40 mol. % to about 85 mol. %, for example about 50 mol. % to about 75 mol. %, ZrO₂ having a molar concentration gradually changing from 5 mol. % to about 60 mol. %, for example about 10 mol. % to about 30 mol. %, and Al₂O₃ having a molar concentration gradually changing from 5 mol. % to about 50 mol. %, for example about 10 mol. % to about 30 mol. %. In another exemplary example, the second feature layer 204 may contain Y₂O₃ having a molar concentration gradually changing from about 55 mol. % to about 65 mol. %, ZrO₂ having a molar concentration gradually changing from 10 mol. % to about 25 mol. %, and Al₂O₃ having a molar concentration gradually changing from 10 mol. % to about 20 mol. %. In yet another exemplary example, the ceramic coating 214 may contain Y₂O₃ having a molar concentration gradually changing from about 55 mol. % to about 65 mol. %, ZrO₂ having a molar concentration gradually changing from 20 mol. % to about 25 mol. %, and Al₂O₃ having a molar concentration gradually changing from 5 mol. % to about 10 mol. %.

In some cases, a third feature layer 206 may be conformally formed on the second feature layer 204. The third feature layer 206 is a silicon-containing layer. The silicon-containing layer may be formed by an atomic layer epitaxy (ALE) or atomic layer deposition (ALD) processes. In cases where ALE is adapted, the third feature layer 206 may be formed by sequentially exposed to a first precursor gas, a purge gas, a second precursor gas, and a purge gas. The first and second precursor gases react to form a chemical compound as a film on the surface of the second feature layer 204. This cycle is repeated to grow the silicon-containing layer in a layer-by-layer fashion until a desired thickness is reached. The silicon-containing layer may have a thickness of about 1 nm to about 5 nm, for example about 2 nm to about 3 nm.

While the foregoing is directed to implementations of the present disclosure, other and further implementations of the disclosure may be devised without departing from the basic scope thereof.

1-11. (canceled)

12. A heat dissipation band for an intercooler, comprising:
a heat dissipation band, the heat dissipation band being in a shape of a continuous sinusoidal waveform having peaks and troughs, and the heat dissipation band comprising a plurality of band bodies formed between peaks and troughs of the waveform, wherein the heat dissipation band is formed of a core material covered by a surface material, and the core material is aluminum alloy 3003 and the surface material is silicon carbide or silicon carbon nitride;
a plurality of protrusions protruding outwardly from a side of each band body;
a first feature layer formed on exposed surface of the heat dissipation band, the first feature layer comprising graphite;
a second feature layer formed on the first feature layer, the second feature layer comprising Y₂O₃, ZrO₂, and Al₂O₃; and
a third feature layer formed on the second feature layer, the third feature layer comprising a silicon-containing layer.

13-17. (canceled)

18. A heat dissipation band for an intercooler, comprising:
a heat dissipation band, the heat dissipation band being in a shape of a continuous sinusoidal waveform having peaks and troughs, and the heat dissipation band comprising a plurality of band bodies formed between peaks and troughs of the waveform, wherein the heat dissipation band is formed of a core material covered by a surface material, and the core material is aluminum alloy 3003 and the surface material is silicon carbon nitride;
a plurality of protrusions protruding outwardly from a side of each band body;
a first feature layer formed on exposed surface of the heat dissipation band, the first feature layer being a bi-layer stack having a layer of borosilicate glass and a layer of polyurethane material;
a second feature layer formed on the first feature layer, the second feature layer comprising Y₂O₃, ZrO₂, and Al₂O₃; and
a third feature layer formed on the second feature layer, the third feature layer comprising a silicon-containing layer.

19. The heat dissipation band of claim 18, wherein the Y₂O₃ is in a range of about 45 mol. % to about 100 mol. %, the ZrO₂ is in a range of about 0 mol. % to about 55 mol. %, and Al₂O₃ is in a range of about 0 mol. % to about 10 mol.

20. The heat dissipation band of claim 18, wherein the Y₂O₃ is in a range of about 30 mol. % to about 60 mol. %, the ZrO₂ is in a range of about 0 mol. % to about 20 mol. %, and Al₂O₃ is in a range of about 30 mol. % to about 60 mol.
